(19) United States
(12) Patent Application Publication
(10) Pub. No.: US 2023/0421256 A1
(43) Pub. Date: Dec. 28, 2023

(54) TECHNOLOGIES FOR A HIGH CHANNEL CAPACITY RADIO FREQUENCY-TO-OPTICAL ATOMIC ANTENNA

(71) Applicant: Otago Innovation Ltd., Dunedin (NZ)

(72) Inventors: Marisol Kate Hunter, Dunedin (NZ); Amita Bikram Deb, Dunedin (NZ); Julia Susanne Otto, Dunedin (NZ); Niels Kjærgaard, Macandrew Bay (NZ)

(73) Assignee: Otago Innovation Ltd., Dunedin (NZ)

(21) Appl. No.: 18/039,152

(22) PCT Filed: Nov. 29, 2021
(86) PCT No.: PCT/IB2021/061089

§ 371 Date: May 26, 2023

Related U.S. Application Data
(60) Provisional application No. 63/119,294, filed on Nov. 30, 2020.

(51) Int. Cl. H04B 10/11; H04B 10/077; H04B 10/50

(52) U.S. Cl. CPC H04B 10/11; H04B 10/077; H04B 10/503

(57) ABSTRACT

Technologies for a multi- or high-channel-capacity radio frequency-to-optical atomic antenna are disclosed. In the illustrative embodiment, several probe beams are sent through an atomic vapor cell that are matched to a transition to an intermediate state of the atoms in the atomic vapor cell. A coupling beam is also sent through the atomic vapor cell that couples the intermediate state to a highly-excited Rydberg state, which causes electromagnetically-induced transparency (EIT) of the probe beams. An applied radio frequency field can interact strongly with the Rydberg state, affecting the EIT effect. As a result, the transmission of the probe beams corresponds to the application of the RF field. The presence of several probe beams can increase the signal-to-noise ratio as well as the bandwidth of a detected signal, increasing the channel capacity of the system.

### CROSS REFERENCE TO RELATED APPLICATIONS

This application claims the benefit of U.S. provisional patent application No. 63/119,294 filed Nov. 30, 2020, and entitled “TECHNOLOGIES FOR A HIGH CHANNEL CAPACITY RADIO FREQUENCY-TO-OPTICAL ATOMIC ANTENNA.” The disclosure of the prior application is considered part of and is hereby incorporated by reference in its entirety in the disclosure of this application.

### BACKGROUND

Modern communication systems are based on a number of key technologies (a) wireless systems such as Wi-Fi, which relies on radio frequency (RF) electromagnetic fields for wireless communication of data over relatively short distances, (b) optical communication where light travelling through optical fibers conveys information, often over very long distances, and/or (c) optical communication where light travelling through free-space conveys information over a short distance (e.g., Radio-over-Free-Space (RoFS) including Light-Fidelity (Li-Fi)). RF-based communication is a vital part of modern communications, enabling compact, portable, and smart telecommunication devices to exchange data and the Internet of Things (IoT). However, these RF-based systems have a relatively short range (typically up to 100 meters). Optical communication, on the other hand, can have a very large range (thousands of kilometers).

Devices that link RF data to optical data therefore constitute an extremely valuable emergent technology. Radio-over-Fiber or Radio-Frequency-over-Fiber (hereinafter referred to as RoF) devices typically allow conversion of RF signals to the optical domain and further transmission via optical fibers.

There is a need for improved data communications system architectures and/or an improved optical antenna with a high channel capacity that will enable direct encoding of free-space RF signals into the optical domain and eliminate the need for any electrical contacts at the receiver end.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of one embodiment of a system for a high channel capacity RF-to-optical atomic antenna;

FIG. 2 is a simplified illustration showing the energy states of atoms provided in a gas or vapor cell, constructed and operative in accordance with embodiments disclosed herein;

FIG. 3 is a graph illustrating transmission of a probe beam at different coupling beam frequencies with and without an RF signal applied;

Each of FIGS. 4-6 is a graph illustrating the effect of an amplitude-modulated RF signal on a transmission of a probe beam at a different probe beam power;

FIG. 7 is a graph illustrating a measured signal-to-noise ratio for a single probe beams at different powers and with different RF frequencies applied;

FIG. 8 is a graph illustrating a measured signal-to-noise ratio for one to four probe beams with different RF frequencies applied; and

FIG. 9 is a graph illustrating a cutoff frequency for one beam at different power levels and different numbers of beams at the same power levels.

### DETAILED DESCRIPTION OF THE DRAWINGS

In the following description, numerous specific details are set forth in order to provide a thorough understanding of the various principles of the present disclosure. However, those skilled in the art will appreciate that not all these details are necessarily always required for practicing the disclosed embodiments.

Although the principles of the present disclosure are largely described herein in relation to data communications between devices, this is an example selected for convenience of presentation, and is not limiting. Those skilled in the art will understand that the principles and the different configurations of the data communications system and/or optical antenna could be applied to many different fields for various applications such as for example, but not limited to, imaging (e.g., medical or security devices), detecting electromagnetic fields, communication between satellites, communication between ground and satellite, electrometry, etc.

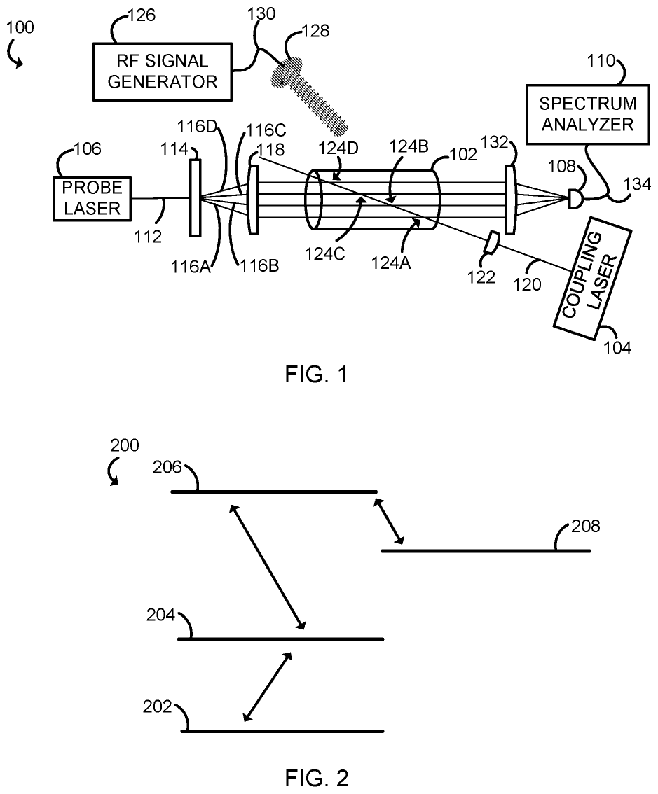

Referring now to FIG. 1, in one embodiment, a system 100 includes an atomic vapor cell 102, a coupling laser 104, a probe laser 106, a detector 108, and a spectrum analyzer 110. In use, a probe beam 112 from the probe laser 106 enters a beam modulator 114 (such as an acousto-optic modulator) that splits the beam into several probe beams 116A, 116B, 116C, and 116D. Each probe beam 116A-D passes through a lens 118 and is focused through the atomic vapor cell 102. Each probe beam 116A-D overlaps with a coupling beam 120 from the coupling laser 104 that is also focused into the atomic vapor cell 102 by lens 122. The probe beams 116A-D and the coupling beam 120 overlap at overlap positions 124A-D, respectively. It should be appreciated that, in the illustrative embodiment, the size of the respective probe beam 116 and the coupling beam 120 are approximately the same at each overlap position 124A-D.

A radio frequency (RF) generator 126 is connected to an antenna 128 by a cable 130. As discussed in more detail below, the RF signal applied to the atomic vapor cell 102 by the antenna 128 can modulate the absorption of the probe beams 116A-D at the overlap positions 124A-D. The probe beams 116A-D are focused by a second lens 132 after the atomic vapor cell 102 onto the detector 108. A cable 134 carries an electrical signal from the detector 108 to the spectrum analyzer 110, where the transmission of the probe beams 116A-D through the atomic vapor cell 102 is analyzed.

Referring now to FIG. 2, an energy level diagram 200 for the atomic vapor in the atomic vapor cell 102 is shown. In the atomic vapor cell 102, at each overlap position 124A-D, a probe beam 116, the coupling beam 120, and a (time-varying) RF field are all present. Each probe beam 116 is tuned to match or closely match a transition from a first state 202 to a second state 204, and the coupling beam 120 is tuned to match a transition from the second state 204 to a third state 206. When a strong coupling beam 120 is applied, the energy levels for the second state 204 are split, affecting absorption of the probe beam 116 and varying the amount of the probe beam 116 measured at the detector 108. This well-known effect is electromagnetically-induced transparency.

In the illustrative embodiment, the third state 206 is a Rydberg state that has a high principal quantum number n. It should be appreciated that the third state 206 has a large electric dipole moment, giving the third state 206 a high sensitivity to applied electric fields. When the RF field is present, the RF field couples the third state 206 to a fourth state 208, which is also a Rydberg state. Due to the Autler-Townes effect, the RF field causes varied absorption of the probe beam 116 due to transitions between the first state 202 and the second state 204. As a result, the transmission of the probe beam 116 can be directly modulated by the presence of an RF field, allowing the atomic vapor cell 102 to act as an atomic antenna.

It should be appreciated that measuring the power of the transmitted probe beams 116A-D at the spectrum analyzer 110 as a function of time allows the electric field from the antenna 128 to be measured as a function of time. As a result, a signal carried by, e.g., an amplitude modulation of the RF field by the RF signal generator 126 can be received by the spectrum analyzer 110. The signal could be any suitable analog or digital signal, such as a Wi-Fi signal. As discussed in more detail below, it should be appreciated that the use of several overlap positions 124A-D may increase the signal-to-noise ratio and/or the bandwidth of the received signal. Additionally or alternatively, in some embodiments, each overlap position 124A-D may be separated by at least one wavelength of the carrier frequency of an applied RF field, allowing for the different overlap positions 124A-D to sample the local RF electric field, which may be different from the local RF electric field at each other overlap position 124A-D. In such an embodiment, each overlap positions 124A-D can act as a different antenna in a multiple input multiple output (MIMO) system. In another embodiment, each overlap position 124A-D could be in one or a number of different vapor cells 102.

In the illustrative embodiment, the atomic vapor cell 102 is a rubidium-87 vapor cell. In the illustrative embodiment, the atomic vapor cell 102 is unenriched and may have different isotopes of rubidium in it. Additionally or alternatively, in some embodiments, the atomic vapor cell 102 may have a different atomic species in it, such as cesium, potassium, any alkali metal, any alkaline earth metal, a buffer species, etc. The illustrative atomic vapor cell 102 is kept at a temperature of approximately 85° C. In other embodiments, the atomic vapor cell 102 may be at any suitable temperatures, such as 15-100° C. The ground state atom density is approximately 10¹² cm⁻³. Additionally or alternatively, in some embodiments, the atomic vapor cell 102 may have a higher or lower ground state atom density, such as 10¹¹-10¹³ cm⁻³. The illustrative atomic vapor cell 102 is cylindrically shaped, with a length of 75 millimeters and a diameter of 25 millimeters.

In the illustrative embodiment, the first state 202 is 5S_{1/2}, the second state 204 is 5P_{3/2}, the third state 206 is 52D_{5/2}, and the fourth state 208 is 51F_{5/2}. The energy difference between the illustrative third state 206 and the illustrative fourth state 208 corresponds to an electromagnetic frequency of 16.532 GHz. It should be appreciated that, in other embodiments, different states may be used in a similar configuration. In particular, the Rydberg states 206, 208 may be any of a large number of Rydberg states with a wide range of energy differences between the third level 206 and the fourth level 208 ranging from tens of megahertz up to one terahertz. As a result, the system 100 can detect modulation of an RF field over a range of carrier frequencies from tens of megahertz up to several terahertz.

The coupling laser 104 is configured to match the transition between the second state 204 and the third state 206. In the illustrative embodiment, the coupling laser 104 has a wavelength of approximately 480 nanometers and has a power of approximately 22 mW. In some embodiments, the power may be higher or lower, such as any power from 10-100 mW. The coupling laser 104 may be any suitable laser, such as a diode laser, a solid state laser, a gas laser, and/or any other suitable type of laser.

The coupling beam 120 is focused by the lens 122 into the atomic vapor cell 102. In the illustrative embodiment, the lens 122 focuses the 22 mW coupling beam 120 to a spot size with a 1/e² waist of 60 micrometers, corresponding to a Rayleigh length of approximately 25 millimeters and a Rabi frequency of approximately 2π×8 MHz.

The probe laser 106 is configured to match the transition between the first state 202 and the second state 204. In the illustrative embodiment, the probe laser 106 has a wavelength of approximately 780 nanometers. In some embodiments, the wavelength of the probe laser 106 may be locked to the transition between the first state 202 and the second state 204 using a second atomic vapor cell (not shown). The probe laser 102 may be any suitable laser, such as a diode laser, a solid state laser, a gas laser, and/or any other suitable type of laser.

The probe beam 112 emitted by the probe laser passes through the beam modulator 114 to generate multiple probe beams 116A-116D. In the illustrative embodiment, the beam modulator 112 is an acousto-optic modulator. Additionally or alternatively, in some embodiments, the beam modulator 114 may be a spatial light modulator, a diffraction grating, a holographic optical element, or any other similar optical or optoelectronic component. In some embodiments, the multiple probe laser beams 116A-D may be generated in a different manner, such as by using beamsplitters, multiple lasers, etc.

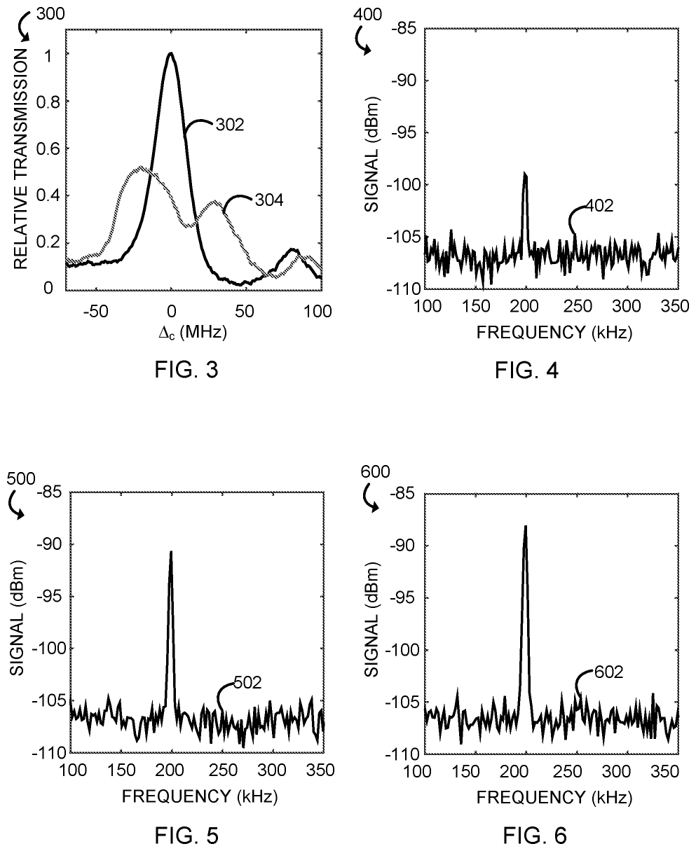

It should be appreciated that, in embodiments using an acousto-optic modulator, the frequency of each probe beam 116A-D will differ slightly. In some embodiments, the difference in frequency can be small enough that each probe beam 116A-D behaves essentially the same in the atomic vapor cell 102. However, in some embodiments, the change in frequency may be enough to substantially change the behavior, such as decreasing (rather than increasing) the transmission of the probe beam 116 in the presence of an RF field. For example, as discussed in more detail in regard to FIG. 3 below, a probe beam 116 of one frequency may have an increase in transmission when an RF field is applied, but a probe beam 116 of at a frequency 40 megahertz higher may have a decrease in transmission when an RF field is applied.

It should be appreciated that the probe beam 112 and probe beams 116A-D are collimated, although probe beams 116A-D are diverging from each other. As a result, the lens 118 both points each probe beam 116A-D in the same direction and also focuses each probe beam 116A-D. Each probe beam 116A-D is focused to a spot size with a 1/e² waist of 70 micrometers. The coupling beam 120 is at an angle of approximately 2° relative to the probe beams 116A-D, leading to a separation of approximately 1.8 millimeters between each overlap position 124A-D.

After passing through the atomic vapor cell 102, each probe beam 116A-116D is directed by the lens to a detector 108. The detector 108 may be any suitable detector, such as a photodiode. In the illustrative embodiment, the photocurrent from a photodiode is converted to voltage signal, which a cable 134 carries to a spectrum analyzer 110. In some embodiments, there may be more than one detector, such as one detector 108 for each of probe beams 116A-D. In some embodiments, each probe beam 116A-D may be directed to each of one or more detectors using one or more lenses (for example, a lens or lenslet array). In some embodiments, a focusing lens 132 before the detector 108 may not be needed.

In some embodiments, the probe beams 116A-D may be coupled into one or more fiber optic cables (such as single- or multi-mode fiber optic cables) or other waveguides before the probe beams 116A-D are detected. In such embodiments, the detector 108 may be located spatially distant from the atomic vapor cell 102, such as any distance between 1 meter and 1,000 kilometers away from the atomic vapor cell 102. In some embodiments, one or more optical amplifiers may be placed between the atomic vapor cell 102 and the detector 108.

The spectrum analyzer 110 may be any suitable spectrum analyzer 110 capable of detecting, analyzing, and/or processing the electrical signal from the detector 108. Additionally or alternatively, in some embodiments, the electrical signal from the detector 108 may be sent to a different type of signal analyzer, such as piece of networking equipment (e.g., a router, switch, gateway, any equivalents, etc.). In such embodiments, the signal in the RF field that becomes imprinted on the probe beams 116A-D may be a signal in a communication protocol, such as Wi-Fi, Ethernet, TCP/IP, etc., and the network equipment may be able to process information received from the detector 108 using the communication protocol. In such embodiments, the RF field that is transmitted to the atomic vapor cell 102 may also be a piece of networking equipment, such as a router, switch, gateway, etc.

The RF signal generator 126 may be any suitable RF signal generator. In the illustrative embodiment, the RF signal generator 126 may generate RF signals at a designated carrier frequency (such as any carrier frequency matching the difference in energy between the third state 206 and the fourth state 208) with an amplitude modulation at a particular frequency, such as DC to tens of megahertz. As noted above, in some embodiments, the RF signal generator 126 may be embodied as a piece of networking equipment capable of transmitting a wireless signal of a communication protocol.

In the illustrative embodiment shown in FIG. 1, the system 100 has four probe beams 116 passing through a single atomic vapor cell 102, interacting with one coupling beam 120, and being detected by a single detector 108. Additionally or alternatively, in other embodiments, more or fewer probe beams 116, more coupling beams 120, more atomic vapor cells 120, and/or more detectors 108 may be used. For example, a system 100 may have several atomic vapor cells 120, each with one or more probe beams 116 passing through each atomic vapor cell 120. In another example, the system 100 may have a detector 108 for each probe beam 116 or may have a detector 108 for each n probe beams 116. For example, a system 100 with four probe beams 116 may have two detectors 108, each of which detects two probe beams 116. Generally, the system 100 may include any suitable number of probe beams 116, such as 2-1,024 probe beams 116. In some embodiments, the system 100 may include several atomic vapor cells 102 that are spatially distributed, such as 1 millimeter to 1,000 meters apart.

In the illustrative embodiment shown in FIG. 1, the system 100 is sensitive to amplitude modulation of the RF field. In some embodiments, the system 100 can be modified to be sensitive to the phase of the RF field in addition to or in place of being sensitive to the amplitude. For example, a local oscillator RF field may be applied at or near the carrier frequency of the RF field being detected. The interference between the local oscillator RF field and the RF field being detected can allow the system 100 to be sensitive to the phase of the RF field being detected.

Referring now to FIG. 3, in use, in one embodiment, the relative transmission of a single probe beam 116 is shown as a function of a detuning of the coupling beam 120. The graph 300 shows both the transmission spectrum 302 when the RF field from the RF signal generator 126 is off and the transmission spectrum 304 when the RF field is on. In the illustrative embodiment, the probe beam 116 is not detuned, giving the contrast shown at 0 MHz in the graph 300. Additionally or alternatively, in some embodiments, one or more of the probe beams 116A-D may be detuned such that the transmission of the probe beam is higher when the RF field is on, such as approximately 30 MHz in the graph 300.

Referring now to FIG. 4, in use, in one embodiment, an amplitude modulated RF signal at 200 kilohertz is applied to the atomic vapor cell 102. As discussed above, the alternating presence and absence of the RF field modulates the transmission of the probe beams 116A-D, and an electrical signal with a 200 kilohertz frequency is detected at the spectrum analyzer 110. A graph 400 shows a signal 402 detected at the spectrum analyzer 110 for a single probe beam 116. The signal 402 has a peak at 200 kilohertz of about −98 dBm, above the noise floor of the spectrum analyzer 110 of approximately −107 dBm, giving a signal-to-noise ratio (SNR) of about 9 dB.

For the graph 400, the power of the probe beam 116 is 25 microwatts. As the power of the probe beam 116 is increased to 50 microwatts, the signal measured at the spectrum analyzer 110 increases, as shown in the signal 502 in the graph 500 in FIG. 5, giving an SNR of about 15 dB. As the power is increased to 100 microwatts, the SNR measured at the spectrum analyzer 110 does not increase as much but rather begins to saturate at about 18 dB, as shown in the signal 602 in the graph 600 in FIG. 6.

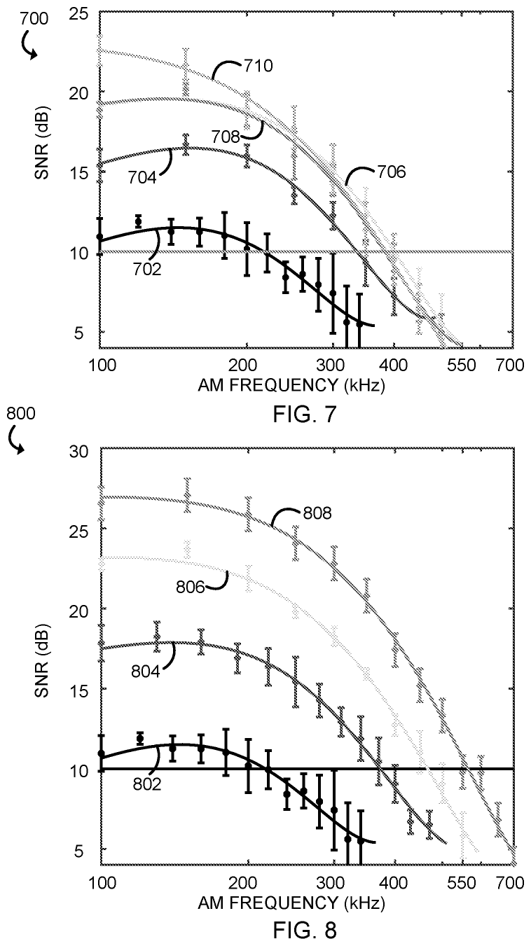

Referring now to FIG. 7, the SNR of the signal received at the spectrum analyzer 110 is plotted as a function of RF amplitude modulation frequency for different powers of a single probe beam 116. Plot 702 corresponds to a probe beam power of 25 microwatts, plot 704 corresponds to a probe beam power of 50 microwatts, plot 706 corresponds to a probe beam power of 75 microwatts, plot 708 corresponds to a probe beam power of 100 microwatts, and plot 710 corresponds to a probe beam power of 450 microwatts. It is evident from the plot that, as the power of the single probe beam 116 is increased, the SNR begins to saturate, and the cutoff frequency at which the SNR is at least 10 dB begins to reach a limit as well.

Referring now to FIG. 8, the SNR of the signal received at the spectrum analyzer 110 is plotted as a function of RF amplitude modulation frequency for several probe beams 116A-D. In particular, plot 802 corresponds to a single probe beam 116, plot 804 corresponds to two probe beams 116, plot 806 corresponds to three probe beams 116, and plot 808 corresponds to four probe beams 116. Each probe beam has a power of 25 microwatts (i.e., the same power as the probe beam in plot 702 in FIG. 7). As a result, the four beams of 25 microwatts each (i.e., plot 808 in FIG. 8) have the same total power as the 100 microwatt plot shown in FIG. 7 (i.e., plot 708). It is evident from comparing FIG. 8 to FIG. 7 that the multibeam configuration shown in FIG. 1 has both an increased SNR as well as an increased bandwidth compared to a single beam with the same total power in the probe beam 116. It should be appreciated that an increased SNR and an increase in bandwidth increase the channel capacity of the system 100 when used to transmit information through the RF field.

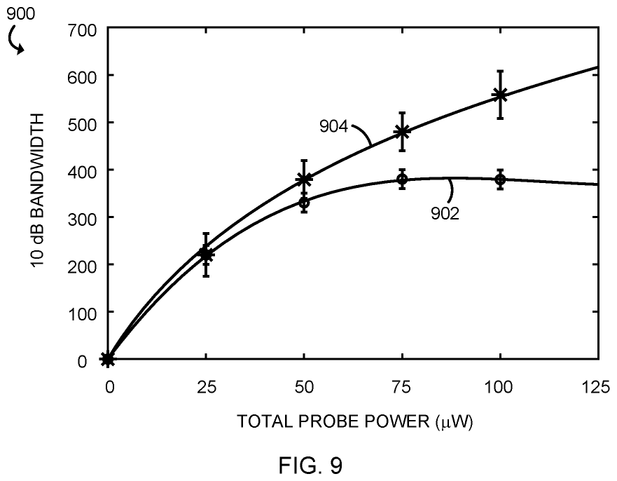

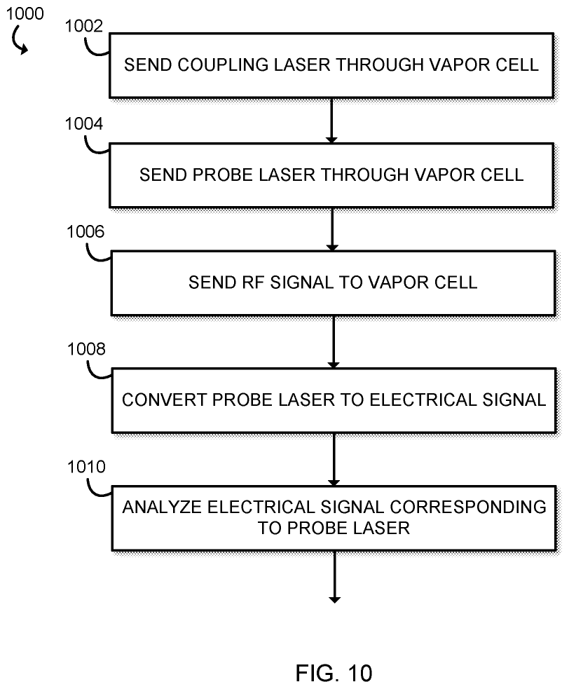

Referring now to FIG. 9, the cutoff bandwidth at which the SNR is below 10 dB is plotted for both a single beam as well as multiple beams. The plot for a single beam is shown in plot 902, with power ranging from 0 to 100 microwatts. The plot for multiple beams is shown in plot 904. For plot 904, each point corresponds to a different number of beams, from zero to four, with each beam having 25 microwatts of power. As shown in FIG. 9, the 10 dB bandwidth saturates for a single beam but continues to increase for additional beams.

As shown in FIGS. 8 & 9, the increase in SNR and bandwidth from multiple beams 116A-D received at a single detector 108 as shown in FIG. 1 can increase the channel capacity of the system 100. In the illustrative embodiment, the channel capacity scales according to the equation C=BW log₂ (1+M×SNR), where C is the channel capacity, BW is the bandwidth range, M is the number of channels (i.e., overlap positions 124), and SNR is the signal-to-noise ratio of a single beam. At a given amplitude modulation frequency f_{AM}, the channel capacity is C=f_{AM} log₂ (1+M×SNR). If the SNR is a function of bandwidth, as is the case for the embodiments described in FIGS. 8 & 9, then the channel capacity can be integrated over the bandwidth range. In the illustrative embodiment, the channel capacity for a single probe beam 116 can be as high as 10-20 megabits per second, and the channel capacity for M probe beams 116 with a single detector 108 scales proportional to log₂(1+M), assuming SNR=1. For example, a system 100 with four probe beams 116 may have a channel capacity as high as 23-46 megabits per second.

Although FIG. 1 shows an embodiment in which multiple beams 116A-D are detected by the same detector 108, it should be appreciated that detecting the multiple beams 116A-D with different detectors 108 may increase the channel capacity of the system 100. For example, in a MIMO system, each overlap position 124A-D may act as an independent channel, leading to a chancel capacity that follows the equation C=BW×N×f_{AM} log₂(1+M×SNR), where N is the number of independent detectors.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

### EXAMPLES

Illustrative examples of the technologies disclosed herein are provided below. An embodiment of the technologies may include any one or more, and any combination of, the examples described below.

Example 1 includes a system for operating a high channel capacity radio frequency-to-optical atomic antenna, the system comprising at least one atomic vapor cell; one or more coupling lasers configured to transmit one or more coupling beams through one or more of the at least one atomic vapor cell; and one or more probe lasers configured to transmit a plurality of probe beams through the one or more of the at least one atomic vapor cell, wherein each of the plurality of probe beams overlaps with at least one of the one or more coupling beams at a corresponding overlap position of the one or more of the at least one atomic vapor cell, wherein the overlap position of each of the plurality of probe beams is different from the overlap position of each other of the plurality of probe beams, wherein the one or more of the at least one atomic vapor cell, the one or more coupling beams, and each of the plurality of probe beams are configured such that absorption of each probe beam at the corresponding overlap position depends on a local radio frequency electric field at the corresponding overlap position.

Example 2 includes the subject matter of Example 1, further comprising one or more detectors to detect each of the plurality of probe beams transmitted through the one or more of the at least one atomic vapor cell to generate one or more electrical signals; and a signal analyzer to analyze the one or more electrical signals to determine a radio frequency electric field inside the one or more of the at least one atomic vapor cell.

Example 3 includes the subject matter of any of Examples 1 and 2, wherein to detect each of the plurality of probe beams comprises to detect each of the plurality of probe beams with a single detector.

Example 4 includes the subject matter of any of Examples 1-3, wherein to analyze the one or more electrical signals comprises to analyze the one or more electrical signals by a networking component based on a communication protocol.

Example 5 includes the subject matter of any of Examples 1-4, wherein the plurality of probe beams are coupled to one or more optical fibers after transmission through the one or more of the at least one atomic vapor cell and prior to detection.

Example 6 includes the subject matter of any of Examples 1-5, further comprising an acousto-optic modulator, wherein the acousto-optic modulator generates the plurality of probe beams.

Example 7 includes the subject matter of any of Examples 1-6, further comprising a spatial light modulator or any other similar optical or optoelectronic component, wherein the spatial light modulator or any other similar optical or optoelectronic component generates the plurality of probe beams.

Example 8 includes the subject matter of any of Examples 1-7, wherein to detect each of the plurality of probe beams comprises to detect each of the plurality of probe beams with a different detector to generate a different electrical signal for each of the plurality of probe beams, wherein to analyze the one or more electrical signals to determine the radio frequency electric field inside the one or more of the at least one atomic vapor cell comprises to analyze the electrical signal for each of the plurality of probe beams to determine information in an independent channel for each of the plurality of probe beams.

Example 9 includes the subject matter of any of Examples 1-8, wherein the probe beam has a frequency corresponding to a transition of atoms of the one or more of the at least one atomic vapor cell from a first quantum state to a second quantum state, and wherein the coupling beam has a frequency corresponding to a transition of atoms of the one or more of the at least one vapor cell from the second quantum state to a Rydberg state.

Example 10 includes the subject matter of any of Examples 1-9, wherein the one or more of the at least one atomic vapor cell is an alkali metal vapor cell.

Example 11 includes a method for operating a high channel capacity radio frequency-to-optical atomic antenna, the method comprising transmitting one or more coupling beams through at least one atomic vapor cell; and transmitting a plurality of probe beams through one or more of the at least one atomic vapor cell, wherein each of the plurality of probe beams overlaps with at least one of the one or more coupling beams at a corresponding overlap position of the one or more of the at least one atomic vapor cell, wherein the overlap position of each of the plurality of probe beams is different from the overlap position of each other of the plurality of probe beams, wherein the one or more of the at least one atomic vapor cell, the one or more coupling beams, and each of the plurality of probe beams are configured such that absorption of each probe beam at the corresponding overlap position depends on a local radio frequency electric field at the corresponding overlap position.

Example 12 includes the subject matter of Example 11, further comprising detecting each of the plurality of probe beams transmitted through the one or more of the at least one atomic vapor cell to generate one or more electrical signals; and analyzing the one or more electrical signals to determine a radio frequency electric field inside the one or more of the at least one atomic vapor cell.

Example 13 includes the subject matter of any of Examples 11 or 12, wherein detecting each of the plurality of probe beams comprises detecting each of the plurality of probe beams with a single detector.

Example 14 includes the subject matter of any of Examples 11-13, wherein analyzing the one or more electrical signals comprises analyzing the one or more electrical signals by a networking component based on a communication protocol.

Example 15 includes the subject matter of any of Examples 11-14, wherein the plurality of probe beams are coupled to one or more optical fibers after transmission through the one or more of the at least one atomic vapor cell and prior to detection.

Example 16 includes the subject matter of any of Examples 11-15, further comprising sending a first probe beam through an acousto-optic modulator to generate the plurality of probe beams.

Example 17 includes the subject matter of any of Examples 11-16, further comprising sending a first probe beam through a spatial light modulator or any other similar optical or optoelectronic component to generate the plurality of probe beams.

Example 18 includes the subject matter of any of Examples 11-17, wherein detecting each of the plurality of probe beams comprises detecting each of the plurality of probe beams with a different detector to generate a different electrical signal for each of the plurality of probe beams, wherein analyzing the one or more electrical signals to determine the radio frequency electric field inside the one or more of the at least one atomic vapor cell comprises analyzing the electrical signal for each of the plurality of probe beams to determine information in an independent channel for each of the plurality of probe beams.

Example 19 includes the subject matter of any of Examples 11-18, wherein the probe beam has a frequency corresponding to a transition of atoms of the one or more of the at least one atomic vapor cell from a first quantum state to a second quantum state, and wherein the coupling beam has a frequency corresponding to a transition of atoms of the vapor cell from the second quantum state to a Rydberg state.

Example 20 includes the subject matter of any of Examples 11-19, wherein the one or more of the at least one atomic vapor cell is an alkali metal vapor cell.

1. A system for operating a high channel capacity radio frequency-to-optical atomic antenna, the system comprising:
at least one atomic vapor cell;
one or more coupling lasers configured to transmit one or more coupling beams through one or more of the at least one atomic vapor cell; and
one or more probe lasers configured to transmit a plurality of probe beams through the one or more of the at least one atomic vapor cell, wherein each of the plurality of probe beams overlaps with at least one of the one or more coupling beams at a corresponding overlap position of the one or more of the at least one atomic vapor cell, wherein the overlap position of each of the plurality of probe beams is different from the overlap position of each other of the plurality of probe beams, wherein the one or more of the at least one atomic vapor cell, the one or more coupling beams, and each of the plurality of probe beams are configured such that absorption of each probe beam at the corresponding overlap position depends on a local radio frequency electric field at the corresponding overlap position.

2. The system of claim 1, further comprising:
one or more detectors to detect each of the plurality of probe beams transmitted through the one or more of the at least one atomic vapor cell to generate one or more electrical signals; and
a signal analyzer to analyze the one or more electrical signals to determine a radio frequency electric field inside the one or more of the at least one atomic vapor cell.

3. The system of claim 2, wherein to detect each of the plurality of probe beams comprises to detect each of the plurality of probe beams with a single detector.

4. The system of claim 2, wherein to analyze the one or more electrical signals comprises to analyze the one or more electrical signals by a networking component based on a communication protocol.

5. The system of claim 2, wherein the plurality of probe beams are coupled to one or more optical fibers after transmission through the one or more of the at least one atomic vapor cell and prior to detection.

6. The system of claim 2, wherein to detect each of the plurality of probe beams comprises to detect each of the plurality of probe beams with a different detector to generate a different electrical signal for each of the plurality of probe beams,
wherein to analyze the one or more electrical signals to determine the radio frequency electric field inside the one or more of the at least one atomic vapor cell comprises to analyze the electrical signal for each of the plurality of probe beams to determine information in an independent channel for each of the plurality of probe beams.

7. The system of claim 1, further comprising an acousto-optic modulator, wherein the acousto-optic modulator generates the plurality of probe beams.

8. The system of claim 1, further comprising a spatial light modulator or any other similar optical or optoelectronic component, wherein the spatial light modulator or any other similar optical or optoelectronic component generates the plurality of probe beams.

9. The system of claim 1, wherein each of the plurality of probe beams has a frequency corresponding to a transition of atoms of the one or more of the at least one atomic vapor cell from a first quantum state to a second quantum state, and
wherein each of the one or more coupling beams has a frequency corresponding to a transition of atoms of the one or more of the at least one atomic vapor cell from the second quantum state to a Rydberg state.

10. The system of claim 1, wherein the one or more of the at least one atomic vapor cell is an alkali metal vapor cell.

11. A method for operating a high channel capacity radio frequency-to-optical atomic antenna, the method comprising:
transmitting one or more coupling beams through at least one atomic vapor cell; and
transmitting a plurality of probe beams through one or more of the at least one atomic vapor cell, wherein each of the plurality of probe beams overlaps with at least one of the one or more coupling beams at a corresponding overlap position of the one or more of the at least one atomic vapor cell, wherein the overlap position of each of the plurality of probe beams is different from the overlap position of each other of the plurality of probe beams, wherein the one or more of the at least one atomic vapor cell, the one or more coupling beams, and each of the plurality of probe beams are configured such that absorption of each probe beam at the corresponding overlap position depends on a local radio frequency electric field at the corresponding overlap position.

12. The method of claim 11, further comprising:
detecting each of the plurality of probe beams transmitted through the one or more of the at least one atomic vapor cell to generate one or more electrical signals; and
analyzing the one or more electrical signals to determine a radio frequency electric field inside the one or more of the at least one atomic vapor cell.

13. The method of claim 12, wherein detecting each of the plurality of probe beams comprises detecting each of the plurality of probe beams with a single detector.

14. The method of claim 12, wherein analyzing the one or more electrical signals comprises analyzing the one or more electrical signals by a networking component based on a communication protocol.

15. The method of claim 12, wherein the plurality of probe beams are coupled to one or more optical fibers after transmission through the one or more of the at least one atomic vapor cell and prior to detection.

16. The method of claim 12, wherein detecting each of the plurality of probe beams comprises detecting each of the plurality of probe beams with a different detector to generate a different electrical signal for each of the plurality of probe beams,
wherein analyzing the one or more electrical signals to determine the radio frequency electric field inside the one or more of the at least one atomic vapor cell comprises analyzing the electrical signal for each of the plurality of probe beams to determine information in an independent channel for each of the plurality of probe beams.

17. The method of claim 11, further comprising sending a first probe beam through an acousto-optic modulator to generate the plurality of probe beams.

18. The method of claim 11, further comprising sending a first probe beam through a spatial light modulator or any other similar optical or optoelectronic component to generate the plurality of probe beams.

19. The method of claim 11, wherein each of the plurality of probe beams has a frequency corresponding to a transition of atoms of the one or more of the at least one atomic vapor cell from a first quantum state to a second quantum state, and
wherein each of the one or more coupling beams has a frequency corresponding to a transition of atoms of the atomic vapor cell from the second quantum state to a Rydberg state.

20. The method of claim 11, wherein the one or more of the at least one atomic vapor cell is an alkali metal vapor cell.
